(19) United States
(12) Patent Application Publication
(10) Pub. No.: US 2025/0142475 A1
(43) Pub. Date: May 1, 2025

(54) TECHNIQUES FOR ON-DEMAND SYNCHRONIZATION SIGNAL BLOCK TRANSMISSION

(71) Applicant: QUALCOMM Incorporated, San Diego, CA (US)

(72) Inventors: Ahmed Attia ABOTABL, San Diego, CA (US); Diana MAAMARI, San Diego, CA (US); Navid ABEDINI, Basking Ridge, NJ (US)

(21) Appl. No.: 18/493,992

(22) Filed: Oct. 25, 2023

(51) Int. Cl. H04W 52/02; H04B 17/318; H04L 5/00; H04W 56/00

(52) U.S. Cl. CPC H04W 52/0235; H04B 17/328; H04L 5/0051; H04W 56/0015

(57) ABSTRACT

Methods, systems, and devices for wireless communications are described that provide for transmission of discovery reference signals (DRSs) by a network entity in an energy saving mode. A user equipment (UE) may measure the DRSs and identify one or more associated synchronization signal blocks (SSBs) that are to be requested. The UE may transmit a wake-up signal (WUS) that includes an identification of one or more requested SSBs, such as a codepoint or bitmap. The network entity may receive the WUS and transmit the requested SSBs.

### FIELD OF TECHNOLOGY

The following relates to wireless communications, including techniques for on-demand synchronization signal block transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for on-demand synchronization signal block transmission. For example, the described techniques provide for transmission of discovery reference signals (DRSs) by a network entity, and a user equipment (UE) may measure the DRSs and identify one or more associated synchronization signal blocks (SSBs) that are to be requested. In some aspects, the UE may transmit a wake-up signal (WUS) that includes an identification of one or more requested SSBs (e.g., a codepoint or bitmap). In some aspects, each codepoint of a set of codepoints may be mapped to different combinations of SSBs that are requested for transmission. In other aspects, a bitmap may have a length that corresponds to a quantity of available SSBs with each bit in the bitmap mapped to a corresponding SSB. Additionally, or alternatively, different preambles of the WUS may be mapped to different SSBs or different combinations of SSBs.

A method for wireless communications by a UE is described. The method may include receiving one or more discovery reference signals, each of the one or more discovery reference signals is associated with a different SSB of a set of multiple on-demand SSBs, transmitting a wake-up signal that identifies at least a first on-demand SSB of the set of multiple on-demand SSBs, the wake-up signal including an indication of at least the first on-demand SSB that is requested for transmission, and monitoring for the first on-demand SSB.

A UE for wireless communications is described. The UE may include one or more memories storing processor executable code, and one or more processors coupled with the one or more memories. The one or more processors may individually or collectively operable to execute the code to cause the UE to receive one or more discovery reference signals, each of the one or more discovery reference signals is associated with a different SSB of a set of multiple on-demand SSBs, transmit a wake-up signal that identifies at least a first on-demand SSB of the set of multiple on-demand SSBs, the wake-up signal including an indication of at least the first on-demand SSB that is requested for transmission, and monitor for the first on-demand SSB.

Another UE for wireless communications is described. The UE may include means for receiving one or more discovery reference signals, each of the one or more discovery reference signals is associated with a different SSB of a set of multiple on-demand SSBs, means for transmitting a wake-up signal that identifies at least a first on-demand SSB of the set of multiple on-demand SSBs, the wake-up signal including an indication of at least the first on-demand SSB that is requested for transmission, and means for monitoring for the first on-demand SSB.

A non-transitory computer-readable medium storing code for wireless communications is described. The code may include instructions executable by a processor to receive one or more discovery reference signals, each of the one or more discovery reference signals is associated with a different SSB of a set of multiple on-demand SSBs, transmit a wake-up signal that identifies at least a first on-demand SSB of the set of multiple on-demand SSBs, the wake-up signal including an indication of at least the first on-demand SSB that is requested for transmission, and monitor for the first on-demand SSB.

Some examples of the method, UEs, and non-transitory computer-readable medium described herein may further include operations, features, means, or instructions for selecting a codepoint or a bitmap that indicates at least the first on-demand SSB from a set of available codepoints or bitmaps that indicate different combinations of the set of multiple on-demand SSBs that are requested for transmission, and where the wake-up signal includes the codepoint or bitmap.

Some examples of the method, UEs, and non-transitory computer-readable medium described herein may further include operations, features, means, or instructions for selecting a preamble for transmission of the wake-up signal from a set of available preambles that indicates at least the first on-demand SSB is requested for transmission. In some examples of the method, UEs, and non-transitory computer-readable medium described herein, each preamble of the set of available preambles is associated with a different combination of on-demand SSBs of the set of multiple on-demand SSBs that are requested for transmission.

Some examples of the method, UEs, and non-transitory computer-readable medium described herein may further include operations, features, means, or instructions for receiving configuration information that indicates a quantity of on-demand SSBs that can be requested by the UE, where the configuration information is received in one or more of radio resource control (RRC) configuration signaling, downlink control information (DCI), or a medium access control (MAC) control element (CE).

Some examples of the method, UEs, and non-transitory computer-readable medium described herein may further include operations, features, means, or instructions for measuring a signal strength of at least two discovery reference signals and identifying a first discovery signal associated with the first on-demand SSB based on the signal strength of each of the at least two discovery reference signals. In some examples of the method, UEs, and non-transitory computer-readable medium described herein, the first discovery signal may be identified based on a reference signal received power (RSRP) that exceeds a RSRP threshold value.

In some examples of the method. UEs, and non-transitory computer-readable medium described herein, the transmitting the wake-up signal may include operations, features, means, or instructions for transmitting the wake-up signal in a first uplink wake-up signal occasion, where the first uplink wake-up signal occasion is associated with a second on-demand SSB that is different than the first on-demand SSB, and where the wake-up signal includes a request for transmission of both the first on-demand SSB and the second on-demand SSB.

In some examples of the method, UEs, and non-transitory computer-readable medium described herein, the request for transmission of the first on-demand SSB may be indicated by a preamble of the wake-up signal that is associated with the first on-demand SSB, and the request for transmission of the second on-demand SSB is indicated by the first uplink wake-up signal occasion used to transmit the wake-up signal.

Some examples of the method, UEs, and non-transitory computer-readable medium described herein may further include operations, features, means, or instructions for retransmitting the wake-up signal on one or more uplink wake-up signal occasions subsequent to an initial transmission of the wake-up signal.

In some examples of the method, UEs, and non-transitory computer-readable medium described herein, the one or more discovery reference signals may be transmitted during a predefined time window, and where on-demand SSBs associated with discovery reference signals transmitted outside of a duration of the predefined time window are not requested by the wake-up signal. In some examples of the method, UEs, and non-transitory computer-readable medium described herein, the first on-demand SSB is requested for multiple periods of SSB transmissions.

A method for wireless communications by a network entity is described. The method may include transmitting a set of multiple discovery reference signals, each of the set of multiple discovery reference signals is associated with a different SSB of a set of multiple on-demand SSBs, receiving, from a UE, a wake-up signal that identifies at least a first on-demand SSB of the set of multiple on-demand SSBs, the wake-up signal including an indication of at least the first on-demand SSB that is requested for transmission, and transmitting at least the first on-demand SSB based on the wake-up signal.

A network entity for wireless communications is described. The network entity may include one or more memories storing processor executable code, and one or more processors coupled with the one or more memories. The one or more processors may individually or collectively operable to execute the code to cause the network entity to transmit a set of multiple discovery reference signals, each of the set of multiple discovery reference signals is associated with a different SSB of a set of multiple on-demand SSBs, receive, from a UE, a wake-up signal that identifies at least a first on-demand SSB of the set of multiple on-demand SSBs, the wake-up signal including an indication of at least the first on-demand SSB that is requested for transmission, and transmit at least the first on-demand SSB based on the wake-up signal.

Another network entity for wireless communications is described. The network entity may include means for transmitting a set of multiple discovery reference signals, each of the set of multiple discovery reference signals is associated with a different SSB of a set of multiple on-demand SSBs, means for receiving, from a UE, a wake-up signal that identifies at least a first on-demand SSB of the set of multiple on-demand SSBs, the wake-up signal including an indication of at least the first on-demand SSB that is requested for transmission, and means for transmitting at least the first on-demand SSB based on the wake-up signal.

A non-transitory computer-readable medium storing code for wireless communications is described. The code may include instructions executable by a processor to transmit a set of multiple discovery reference signals, each of the set of multiple discovery reference signals is associated with a different SSB of a set of multiple on-demand SSBs, receive, from a UE, a wake-up signal that identifies at least a first on-demand SSB of the set of multiple on-demand SSBs, the wake-up signal including an indication of at least the first on-demand SSB that is requested for transmission, and transmit at least the first on-demand SSB based on the wake-up signal.

Some examples of the method, network entities, and non-transitory computer-readable medium described herein may further include operations, features, means, or instructions for decoding a codepoint or a bitmap from the wake-up signal that indicates at least the first on-demand SSB, where the codepoint or bitmap is from a set of available codepoints or bitmaps that indicate different combinations of the set of multiple on-demand SSBs that are requested for transmission.

Some examples of the method, network entities, and non-transitory computer-readable medium described herein may further include operations, features, means, or instructions for identifying the first on-demand SSB is requested based on a preamble of the wake-up signal. In some examples of the method, network entities, and non-transitory computer-readable medium described herein, each preamble of a set of available preambles may be associated with a different combination of on-demand SSBs of the set of multiple on-demand SSBs that are requested for transmission.

Some examples of the method, network entities, and non-transitory computer-readable medium described herein may further include operations, features, means, or instructions for transmitting configuration information to the UE that indicates a quantity of on-demand SSBs that can be requested by the UE, where the configuration information is transmitted in one or more of RRC configuration signaling, DCI, or a MAC-CE.

Some examples of the method, network entities, and non-transitory computer-readable medium described herein may further include operations, features, means, or instructions for transmitting configuration information to the UE that configures the UE to select a first discovery reference signal associated with the first on-demand SSB based on a signal strength of two or more measured discovery reference signals. In some examples of the method, network entities, and non-transitory computer-readable medium described herein, the configuration information includes a RSRP threshold value for selecting one or more discovery reference signals.

In some examples of the method, network entities, and non-transitory computer-readable medium described herein, the receiving the wake-up signal may include operations, features, means, or instructions for receiving the wake-up signal in a first uplink wake-up signal occasion, where the first uplink wake-up signal occasion is associated with a second on-demand SSB that is different than the first on-demand SSB, and where the wake-up signal includes a request for transmission of both the first on-demand SSB and the second on-demand SSB.

In some examples of the method, network entities, and non-transitory computer-readable medium described herein, the request for transmission of the first on-demand SSB may be indicated by a preamble of the wake-up signal that is associated with the first on-demand SSB, and the request for transmission of the second on-demand SSB is indicated by the first uplink wake-up signal occasion used to transmit the wake-up signal.

Some examples of the method, network entities, and non-transitory computer-readable medium described herein may further include operations, features, means, or instructions for receiving one or more instances of the wake-up signal on at least one uplink wake-up signal occasion of a set of uplink wake-up signal occasions. In some examples of the method, network entities, and non-transitory computer-readable medium described herein, the set of multiple discovery reference signals are transmitted during a predefined time window, and where on-demand SSBs associated with discovery reference signals transmitted outside of a duration of the predefined time window are not requested by the wake-up signal. In some examples of the method, network entities, and non-transitory computer-readable medium described herein, the first on-demand SSB is requested for multiple periods of SSB transmissions.

### BRIEF DESCRIPTION OF THE DRAWINGS

FIG. 1 shows an example of a wireless communications system that supports techniques for on-demand synchronization signal block (SSB) transmission in accordance with one or more aspects of the present disclosure.

FIG. 2 shows an example of a portion of a wireless communications system that supports techniques for on-demand SSB transmission in accordance with one or more aspects of the present disclosure.

FIG. 3 shows an example of a wake-up signal transmission that supports techniques for on-demand SSB transmission in accordance with one or more aspects of the present disclosure.

FIG. 4 shows an example of a process flow that supports techniques for on-demand SSB transmission in accordance with one or more aspects of the present disclosure.

FIGS. 5 and 6 show block diagrams of devices that support techniques for on-demand SSB transmission in accordance with one or more aspects of the present disclosure.

FIG. 7 shows a block diagram of a communications manager that supports techniques for on-demand SSB transmission in accordance with one or more aspects of the present disclosure.

FIG. 8 shows a diagram of a system including a device that supports techniques for on-demand SSB transmission in accordance with one or more aspects of the present disclosure.

FIGS. 9 and 10 show block diagrams of devices that support techniques for on-demand SSB transmission in accordance with one or more aspects of the present disclosure.

FIG. 11 shows a block diagram of a communications manager that supports techniques for on-demand SSB transmission in accordance with one or more aspects of the present disclosure.

FIG. 12 shows a diagram of a system including a device that supports techniques for on-demand SSB transmission in accordance with one or more aspects of the present disclosure.

FIGS. 13 through 19 show flowcharts illustrating methods that support techniques for on-demand SSB transmission in accordance with one or more aspects of the present disclosure.

### DETAILED DESCRIPTION

A wireless communications system may include a device, such as a user equipment (UE) or a network entity (e.g., an eNodeB (eNB), a next-generation NodeB or a giga-NodeB, either of which may be referred to as a gNB, or some other base station or network entity), that supports wireless communications using one or multiple radio access technologies. Examples of radio access technologies include 4G systems, such as LTE systems, 5G systems, which may be referred to as NR systems, or other systems and radio technologies, including future systems and radio technologies not explicitly mentioned herein (e.g., sixth generation (6G) systems and beyond).

In some wireless communications systems, such as fifth generation (5G) or NR systems, a relatively large amount of power may be consumed by network components in some situations. For example, a network entity in a system that uses beamformed communications, such as a radio unit (RU) or a radio head, may transmit multiple directional beams in multiple directions. Such systems may provide information for use by a UE to access the wireless communications system (e.g., system information that provides parameters for system access) using beam sweeping techniques in which information is provided in multiple different transmissions in multiple different directions. For example, multiple instances of synchronization signal blocks (SSBs) and system information (SI) transmissions (e.g., remaining minimum system information (RMSI) transmissions) may be transmitted across multiple beams in multiple different directions according to a beam sweeping procedure. Such beam sweeping techniques may consume additional power relative to techniques that do not use beam sweeping (e.g., information provided in a single omni-directional transmission may consume less power than transmission of multiple instances of the information in multiple different directions). Further, such beam sweeping transmissions may be transmitted on multiple different cells, such as a primary cell (PCell) and one or more secondary cells (SCells).

In some cases, in order to reduce network power consumption, a network entity may transition to a sleep mode or idle mode in which transmit and receive circuitry is powered down. For example, during off-peak times, there may be no traffic or a light traffic load in a cell, and the network entity may stop or reduce periodic transmissions (e.g., SSB and SI transmissions) and periodic monitoring (e.g., monitoring for random access requests or small data transmission (SDT) communications), and transition to the sleep mode in which periodic active periods are used to monitor for a wake-up signal (WUS) from a served device such as a UE. If the network entity does not detect a WUS, it transitions back to the sleep mode. If one or more WUS is detected, the network entity may maintain an active mode or initiate an active mode in addition to periods during which WUSs are monitored. In some cases, such sleep mode operations may be implemented on one or more SCells, which may have less control communications than a PCell and thus are more likely to have periods with light or no traffic, although such techniques may also be used in PCells in some conditions. In some cases, a UE may be configured with a periodicity at which WUSs may be transmitted in accordance with periods during which a cell will monitor for WUSs, which may be referred to as WUS occasions. If data traffic is present in the UE transmit buffer, the UE may transmit a WUS during a WUS occasion to trigger the cell to start or maintain an active state to allow for communications of the UE's data traffic.

In some cases, a network entity may transmit DRSs (DRSs), which may also be referred to as ‘light SSBs,’ and a UE that receives such transmissions may transmit a WUS in an associated uplink WUS occasion to trigger transmission of the corresponding SSB. The WUS occasion may be selected based on, for example, a power measurement of the associated DRS (e.g., a RSRP measurement). However, in some cases two or more received DRSs may indicate that the corresponding SSBs are good candidates for communications at a UE, and the UE may request each such SSB. In some prior proposals, such techniques require that the UE transmit separate WUSs for each identified DRS, which can consume a significant amount of overhead. In accordance with various aspects discussed herein, a WUS may indicate two or more SSBs are requested, and may thus efficiently request multiple SSBs (e.g., multiple on-demand SSBs).

In accordance with various aspects discussed herein, techniques are provided in which a UE may measure DRSs and identify one or more associated SSBs that are to be requested. The UE may transmit a WUS that includes an identification of the requested SSB, such as in a codepoint or bitmap. In some aspects, each codepoint of a set of codepoints may be mapped to different combinations of SSBs that are requested for transmission. Similarly, a bitmap may have a length that corresponds to a quantity of available SSBs with each bit in the bitmap mapped to a corresponding SSB. In other aspects, different preambles of the WUS may be mapped to different SSBs, or to different combinations of SSBs. In some aspects, each DRS may have an associated uplink WUS occasion on which a WUS may be transmitted, and a network entity that receives the WUS on the WUS occasion may identify the corresponding SSB. In such cases, the WUS may include a separate identification of one or more other SSBs that are requested in addition to the SSB of the corresponding WUS occasion. Additionally, or alternatively, the WUS may be repeated on multiple occasions for increased reliability. In some aspects, the network entity may configure the UE with predefined window over which this indication is applicable, and the indication also may be applicable to multiple periods that may be configured by the network.

Various techniques as discussed herein may provide one or more UE and network enhancements and efficiencies. For example, a network entity may transition to a sleep mode and network power savings may be achieved, and DRSs may be transmitted periodically, which consume less power than transmission of full SSBs and provide additional power savings. A UE may monitor for DRSs and transmit a WUS that indicates two or more selected DRSs to trigger transmission of associated SSBs, which may enhance efficiency through reduced WUS transmissions and increased link reliability for subsequent communications. Thus, such techniques may provide for enhanced reliability of communications links for communications when in a network energy savings mode, and also provide reduced latency due to fewer WUS transmissions. Further, SSB transmissions triggered by a WUS may allow for beam selection of more reliable beams, which may further enhance reliability and reduce latency, thus enhancing system efficiency and providing an enhanced user experience.

Aspects of the disclosure are initially described in the context of wireless communications systems. Aspects of the disclosure are further illustrated by and described with reference to signaling diagrams, process flows, apparatus diagrams, system diagrams, and flowcharts that relate to techniques for on-demand SSB transmission.

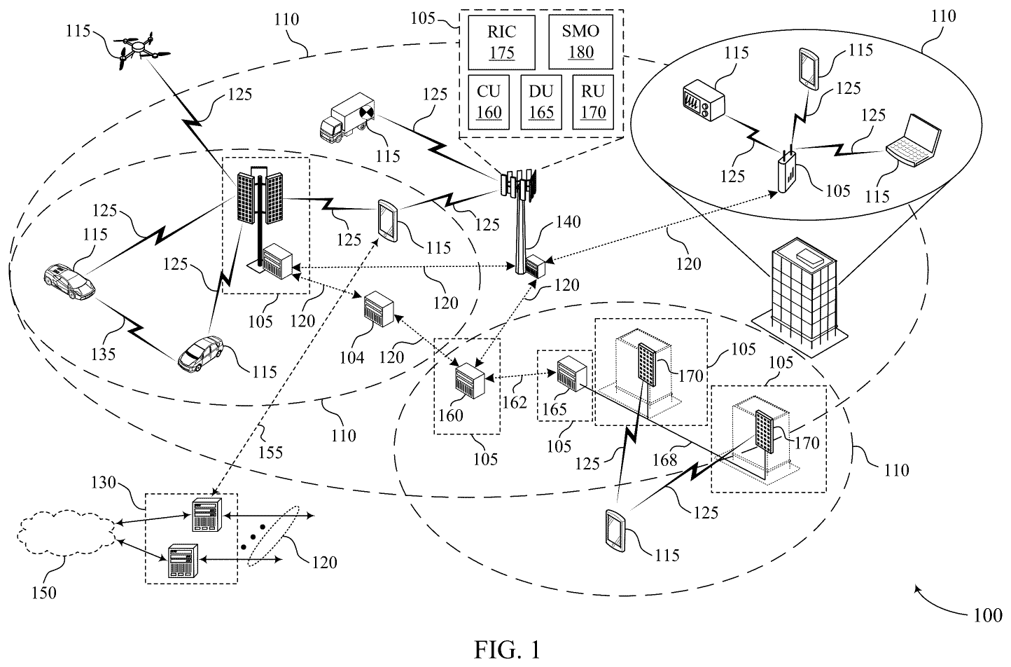

FIG. 1 shows an example of a wireless communications system 100 that supports techniques for on-demand SSB transmission in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for on-demand SSB transmission as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, one or more network entities 105 may transmit DRSs, and a UE 115 may measure the DRSs and identify one or more associated SSBs that are to be requested. In some aspects, the UE 115 may transmit a WUS that includes an identification of one or more requested SSBs. In some aspects, the WUS may include a codepoint, where each codepoint of a set of codepoints is mapped to different combinations of SSBs that are requested for transmission. In other aspects, a bitmap may have a length that corresponds to a quantity of available SSBs with each bit in the bitmap mapped to a corresponding SSB, and a value of the bit indicates whether the corresponding SSB is requested or not. Additionally, or alternatively, different preambles of the WUS may be mapped to different SSBs or different combinations of SSBs.

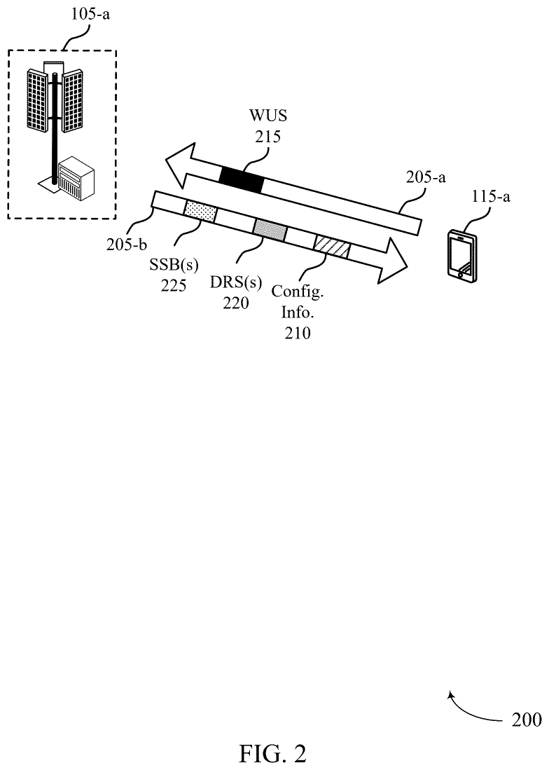

FIG. 2 shows an example of a wireless communications system 200 that supports techniques for on-demand SSB transmission in accordance with one or more aspects of the present disclosure. The wireless communications system 200 may implement or be implemented by aspects of the wireless communications system 100. For example, the wireless communications system 200 may include a network entity 105-a and a UE 115-a, which may be examples of a network entity 105 (e.g., an RU 170, a DU 165, a CU 160, a base station 140, or some combination thereof) and a UE 115 as described with reference to FIG. 1. The network entity 105-a and the UE 115-a may communicate with one another via an uplink channel 205-a and a downlink channel 205-b, which may be examples or components of a communication link 125 as described with reference to FIG. 1. The UE 115-a and network entity 105-a may support techniques for WUS transmissions that indicate one or multiple SSBs are requested from the network entity 105 operating in an energy saving mode. By providing on-demand SSB request techniques, the UE 115-a and network entity 105-a may reduce a quantity of WUSs that may be transmitted when multiple SSBs are requested, which may promote resource efficiency, reduced latency, and enhanced reliability, while also providing for reduced power consumption for the wireless communications system 200.

In the example of FIG. 2, the network entity 105-a may transmit configuration information 210 to the UE 115-a. In some cases, the configuration information 210 may include information related to cell sleep and active mode periods and WUS occasions. The configuration information may also configure the UE 115-a to provide an indication in a WUS 215 of one or more SSBs 225 that are requested in cases where the network entity 105-a is operating in an energy saving mode. The network entity 105-a may initiate a sleep procedure at a cell (e.g., a SCell or PCell that is configured at the UE 115-a) based on the configuration information 210. At periodic times while in the sleep procedure, the network entity 105-a may transmit DRSs 220 that may be monitored at the UE 115-a to identify one or multiple SSBs 225 that are good candidates (e.g., based on RSRPs of the DRSs 220) for establishing a reliable link for communications. In the event that the UE 115-a has traffic in a transmit buffer, the UE 115-a may transmit a WUS 215 during a WUS occasion based on the configuration information 210. The network entity 105-a may detect the WUS 215, and transmit the one or more SSBs 225 to the UE 115-a.

In accordance with various aspects discussed herein, the configuration information 210 may provide for WUS transmissions that include an indication of one or multiple SSBs that are requested at the UE 115-a. In accordance with various aspects, the UE 115-a may measure two or more DRSs 220 and identify one or more associated SSBs that are to be requested. For example, the network entity 105-a may transmit DRSs 220 that include less information than a full SSB (e.g., a light SSB that includes a reference signal for measurements at the UE 115-a and an associated identifier of a SSB), where the DRSs 220 are transmitted on different beams. The UE 115-a may measure the DRSs 220 and identify that two or more SSBs 225 are to be requested in the WUS 215. The UE 115-a may transmit the WUS 215 that includes an identification of the requested SSBs 225. In some cases, the indication in the WUS 215 may be provided by a codepoint or bitmap. In cases where the WUS 215 includes a codepoint, each codepoint of a set of codepoints may be mapped to different combinations of SSBs 225 (e.g., that are provided in the configuration information 210, or that are specified according to a communications standard or protocol) that are requested for transmission. In cases where the WUS 215 includes a bitmap, the bitmap may have a length that corresponds to a quantity of available SSBs with each bit in the bitmap mapped to a corresponding SSB. In such cases, the WUS 215 may include the bitmap with bits set to indicate which of the available SSBs 225 are requested by the UE 115-a. In some aspects, the quantity of SSBs 225 the UE 115-a can request may be provided in the configuration information 210 (e.g., via radio resource control (RRC) signaling, one or more MAC-CEs, downlink control information (DCI), or any combinations thereof).

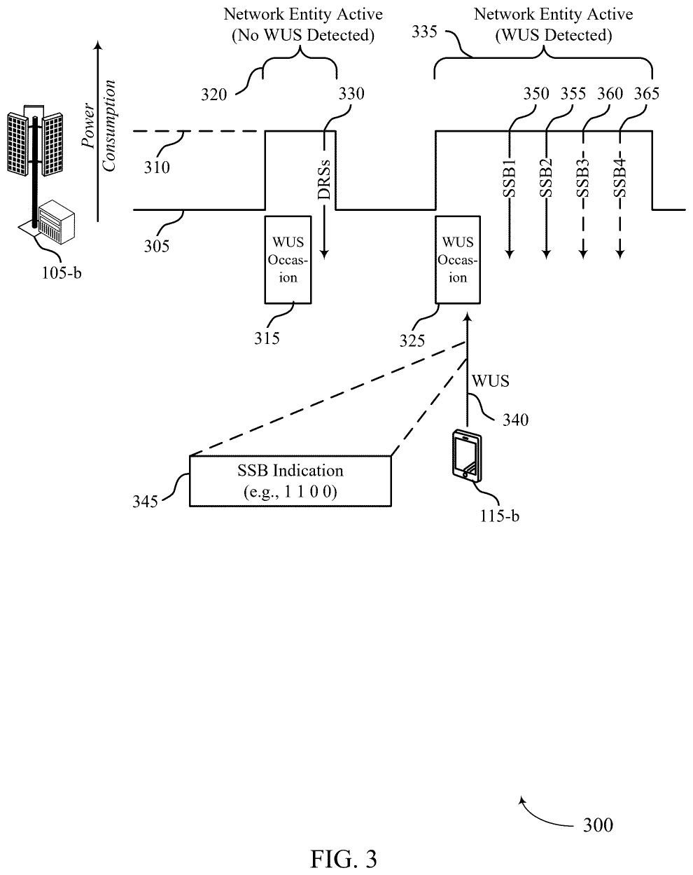

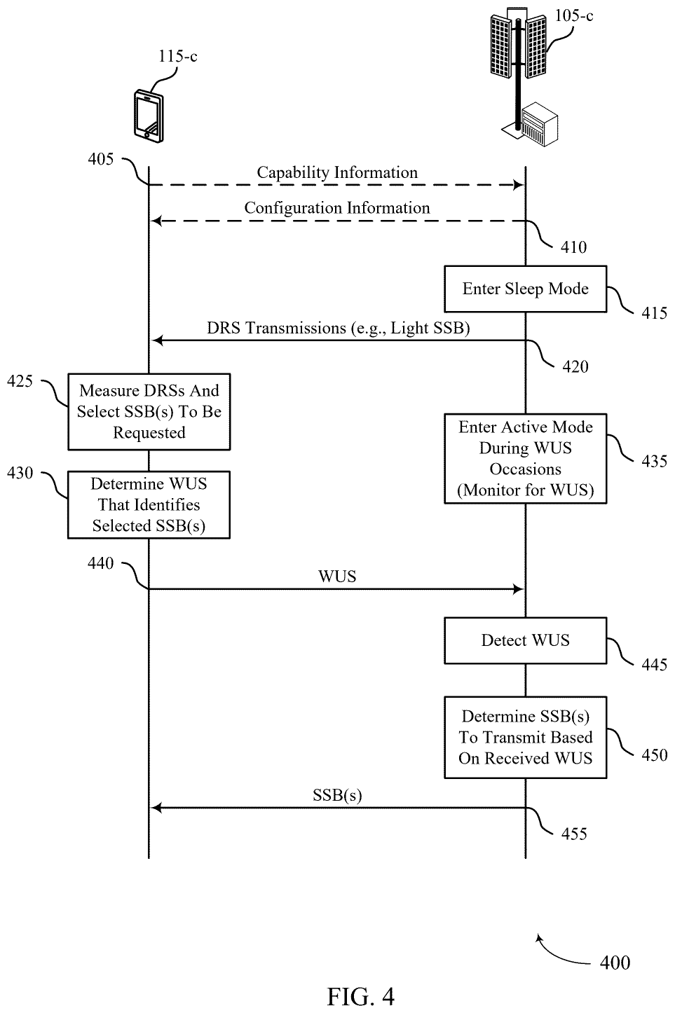

Additionally, or alternatively, different preambles of the WUS 215 may be mapped to different SSBs 225, or to different combinations of SSBs 225. In such cases, the configuration information 210 may configure the indication of a requested SSB 225 using a preamble. For example, the configuration information 210 may provide a set of preambles, with each preamble associated with a different SSB 225 or different combination of SSBs 225, and the UE 115-a may select a preamble of the set of preambles based on the measured DRSs 220 and associated SSBs 225, to indicate the requested SSBs. In other examples, the set of preambles and associated SSB(s) may be prespecified in a communications standard or protocol. In some aspects, each DRS 220 may have an associated uplink WUS 215 occasion on which a WUS 215 may be transmitted. The network entity 105-a may receive the WUS 215 on the WUS occasion and may identify the corresponding SSB 225. In such cases, the WUS 215 may include a separate identification of one or more other SSBs 225 that are requested in addition to the SSB 225 of the corresponding WUS occasion. In some further aspects, the WUS 215 may be repeated on multiple occasions for increased reliability. Additionally, or alternatively, the network entity 105-a may configure the UE 115-a with predefined window over which an indication in a WUS 215 is applicable, and the indication also may be applicable to multiple periods that may be configured by the network entity 105-a. For example, a period associated with the WUS 215 may correspond to a quantity of DRSs 220 that are able to be indicated in the WUS 215 (e.g., based on available combinations for a quantity of bits of a codepoint or a quantity of bits in a bitmap). Additional examples of WUS occasions, WUS 215 transmissions, and indications of requested SSBs 225, are discussed with reference to FIGS. 3 and 4.

FIG. 3 shows an example of a WUS transmission 300 that supports techniques for on-demand SSB transmission in accordance with one or more aspects of the present disclosure. The WUS transmission 300 may be implemented by aspects of the wireless communications system 100 or 200. For example, a UE 115-b and network entity 105-b, which may be examples of UEs 115 and network entities 105 of FIGS. 1 and 2, may implement the WUS transmission 300. As discussed herein, network entity 105-b may transition between a sleep mode 305 and an active mode 310, where the sleep mode 305 has lower power consumption than the active mode 310. A WUS configuration may be provided that may trigger the network entity 105-b to remain in the active mode 310 for communications, thus allowing for reduced network power consumption and efficient wake-up procedures, which may enhance overall network efficiency and user experience.

In the example of FIG. 3, the network entity 105-b enters sleep mode 305 that provides network power saving, in which periodic active modes 310 may be used to monitor for WUSs, transmit DRSs, and maintain network operation. In some cases, a sleep procedure may be enabled at the network entity 105-b based on traffic loads that are being served. For example, during certain hours (e.g., night hours in office areas) there may be relatively light traffic or no traffic for a cell, and the sleep procedure may help save network power and operational cost. In some cases, different sleep modes may be configured, where some sleep modes will turn off RF chains at the network entity 105-b while others may not, and thus different sleep modes have different power consumption and may have different transition times. In the example of FIG. 3, the network entity 105-b may configure periodic occasions for monitoring for a WUS, which include a first WUS occasion 315 and a second WUS occasion 325 in this example. In this example, during active period 320 associated with the first WUS occasion 315, the network entity 105-b may not detect a WUS and may transition back to sleep mode 305. Also, in this example, the network entity 105-b may transmit a set of DRSs 330 according to a beam sweeping pattern, and the UE 115-b may monitor for the DRSs 330 and measure the received DRSs 330 (e.g., to obtain RSRP values).

In this example, the UE 115-b may determine that communications with the network entity 105-b are to be activated (e.g., based on a presence of data at a data buffer of the UE 115-b). The UE 115-b in this example may identify two or more DRSs that meet a criteria for requesting an associated SSB. For example, if a RSRP of a DRS exceeds a RSRP threshold value, the DRS may be identified for requesting an associated SSB. In other examples, a configured or predefined quantity of highest strength DRSs may be identified for requesting associated SSBs. During active period 335 associated with second WUS occasion 325, the UE 115-b may transmit WUS 340 that indicates the requested SSBs in SSB indication 345, and the network entity 105-b may detect WUS 340 from the UE 115-b, and may maintain the active mode 310 beyond the duration of the second WUS occasion 325 in order to provide communications with the UE 115-b. As discussed herein, the WUS 340 may include a codepoint or bitmap to indicate the requested SSBs, or may use a preamble that indicates the requested SSBs. In the example of FIG. 3, a bitmap is illustrated that includes four bits, and requests transmission of a first SSB 350 and a second SSB 355, and does not request transmission of a third SSB 360 or a fourth SSB 365. The network entity 105-b may receive the WUS 340, and transmit the requested SSBs, including the first SSB 350 and the second SSB 355 in this example.

In some cases, the WUS 340 may have different forms such as a RACH preamble or PUCCH transmission. For example, the WUS 340 may be a RACH request that includes a RACH preamble that is selected from a set of RACH preambles that are mapped to different combinations of requested SSBs. In other cases, the WUS 340 may be a physical uplink control channel (PUCCH) transmission, such as a scheduling request (SR) transmission, and may include a payload that indicates a codepoint or bitmap as discussed herein. In further examples, the second WUS occasion 325 may be associated with a first beam and a corresponding first SSB, and the WUS 340 associated with the first beam may not need to indicate explicitly a request for the first SSB (due to being already implicitly indicated), and the WUS 340 may indicate one or more other indices (e.g., preamble ID=i sent on a WUS occasion n may indicate a UE request for SSB n and an additional SSB associated with beam n+i mod N, where N is the number of configured beams).

FIG. 4 shows an example of a process flow 400 that supports techniques for on-demand SSB transmission in accordance with one or more aspects of the present disclosure. The process flow 400 may include a network entity 105-c and a UE 115-c, which may be examples of a network entity 105 and a UE 115 as described with reference to FIGS. 1, 2, and 3. The process flow 400 may be implemented by the network entity 105-c and the UE 115-c where a WUS from the UE 115-c provides an indication of cell activation and two or more requested SSBs. Such techniques may provide for power savings at the network entity 105-c associated with a sleep mode, while also enabling transmissions of multiple SSBs based on a single WUS, which may thereby enhance overall network efficiency and user experience. In the following description of the process flow 400, the operations between the network entity 105-c and the UE 115-c may be performed in a different order than the example order shown. Some operations may be omitted from the process flow 400, and other operations may be added to the process flow 400.

At 405, optionally, the UE 115-c may transmit a capability information message that indicates to the network entity 105-c a capability for transmitting WUSs that indicate two or more requested SSBs. In some cases, the capability information message may be transmitted via RRC signaling, one or more MAC-CEs, uplink control information (UCI), or any combinations thereof.

At 410, optionally, the network entity 105-c may transmit, and the UE 115-c may receive, configuration information associated with WUS transmissions. As discussed herein, such configuration information may provide characteristics of WUS occasions, such as, for example, a duration of WUS occasions (e.g., a time duration or quantity of symbols/slots), a periodicity of WUS occasions (e.g., time period, quantity of symbols/slots and symbol/slot offset), a frequency band or bandwidth part (BWP), or any combinations thereof. In some aspects, the configuration information may provide a mapping between different codepoints of a set of codepoints and different combinations of requested SSBs, may provide a bitmap configuration for requested SSBs, may provide a mapping between different preambles of a set of preambles and different combinations of requested SSBs, or any combinations thereof. In some cases, the configuration information may be provided via RRC signaling. In some cases, additionally, or alternatively, the configuration information may be provided with one or more system information transmissions (e.g., SIB/MIB transmissions), in one or more control channel transmissions (e.g., in DCI), and/or in one or more MAC-CE transmissions.

At 415, the network entity 105-c may transition to a sleep mode. In some cases, the sleep mode may be a relatively low power mode at the network entity 105-c in which some or all transmit/receive components are powered down.

At 420, the network entity 105-c may transmit DRS transmissions (e.g., light SSBs). In some cases, the DRS transmissions may be transmitted according to a beam sweeping transmission pattern that corresponds to a SSB beam sweeping pattern that would be used at the network entity 105-c when in an active mode. In some cases, the DRS may include less information than an SSB. For example, a SSB may occupy four OFDM symbols and include a primary synchronization signal (PSS), secondary synchronization signal (SSS), and a physical broadcast channel (PBCH), and a DRS or light SSB may include, for example, only a downlink reference signal and an index value associated with the beam used for transmission, and may occupy one OFDM symbol.

At 425, the UE 115-c may measure received DRSs (e.g., to obtain RSRP values for each measured DRS) and select one or more SSBs that are to be requested. In some cases, the one or more SSBs may be selected based on highest RSRP values (e.g., a configured or predefined quantity of highest RSRP values), or based on RSRP values that exceed a RSRP threshold value (e.g., a configured or predefined threshold value).

At 430, the UE 115-c may identify that a WUS is to be transmitted, and determine an identification of the selected SSB(s). Such determinations may be made in accordance with various techniques discussed herein, such as based on a codepoint configuration, bitmap configuration, or preamble configuration that identifies one or more available SSBs that are requested.

At 435, the network entity 105-c may transition to an active mode to monitor for WUS communications during configured WUS occasions. In some cases, the transition to the active mode may be performed in accordance with a WUS occasion periodicity that is indicated in the configuration information.

At 440, the UE 115-c may transmit the WUS to the network entity 105-c, where the WUS includes an indication of requested SSBs. The indication of the requested SSBs may be provided in accordance with various techniques as discussed herein. In some cases, the WUS may include an ID of the UE 115-c. As discussed herein, the WUS may be transmitted during a WUS occasion. In some aspects, two or more instances of the WUS may be transmitted to enhance the likelihood of successful reception at the network entity 105-c.

At 445, the network entity 105-c may detect the WUS. At 450, the network entity 105-c may determine one or more SSBs that are to be transmitted based on the indication provided in the received WUS. At 455, the network entity 105-c may transmit, and the UE 115-c may receive, the one or more requested SSBs. The UE 115-c, based on the reception of the SSB(s), may perform connection establishment or reestablishment based on information and signals in the SSB(s) in accordance with established techniques.

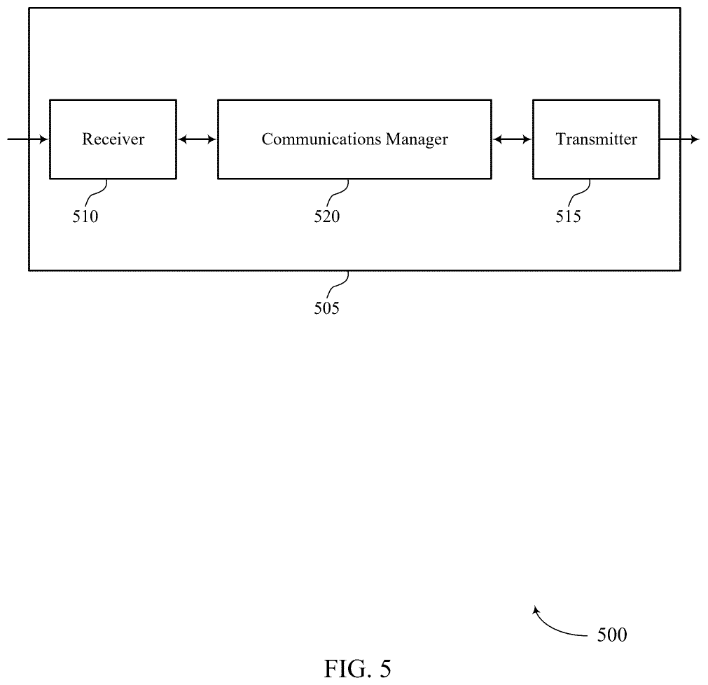

FIG. 5 shows a block diagram 500 of a device 505 that supports techniques for on-demand SSB transmission in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for on-demand SSB transmission). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for on-demand SSB transmission). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for on-demand SSB transmission as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving one or more DRSs, each of the one or more DRSs is associated with a different SSB of a set of multiple on-demand SSBs. The communications manager 520 is capable of, configured to, or operable to support a means for transmitting a WUS that identifies at least a first on-demand SSB of the set of multiple on-demand SSBs, the WUS including an indication of at least the first on-demand SSB that is requested for transmission. The communications manager 520 is capable of, configured to, or operable to support a means for monitoring for the first on-demand SSB.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for WUS transmission that request on-demand SSB transmissions of one or multiple SSBs, which can provide for reduced quantities of WUS transmissions and may enhance network efficiency and reliability, and reduce power consumption.

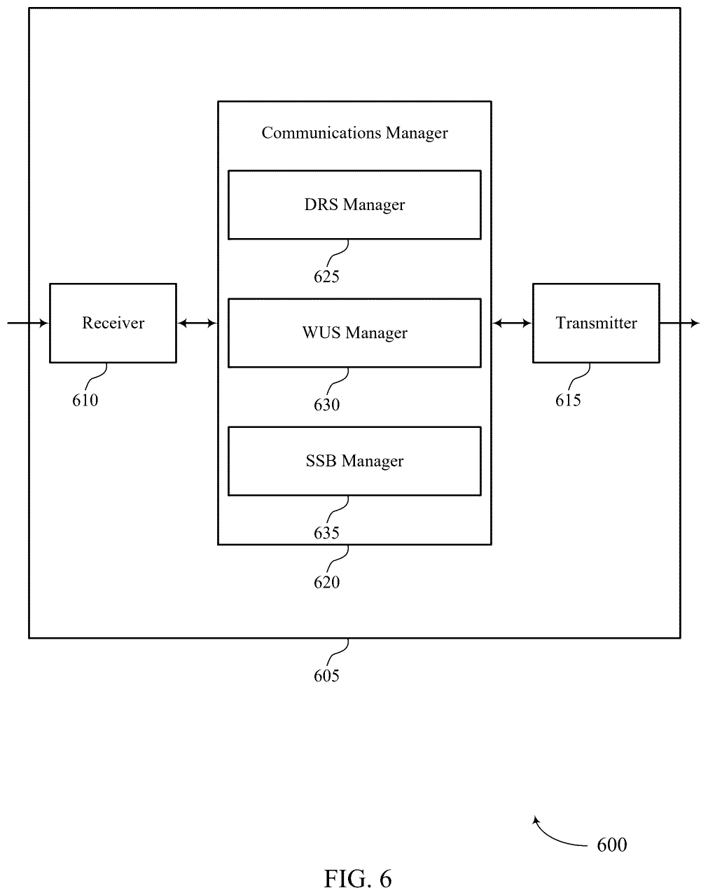

FIG. 6 shows a block diagram 600 of a device 605 that supports techniques for on-demand SSB transmission in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for on-demand SSB transmission). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for on-demand SSB transmission). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for on-demand SSB transmission as described herein. For example, the communications manager 620 may include a DRS manager 625, a WUS manager 630, an SSB manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The DRS manager 625 is capable of, configured to, or operable to support a means for receiving one or more DRSs, each of the one or more DRSs is associated with a different SSB of a set of multiple on-demand SSBs. The WUS manager 630 is capable of, configured to, or operable to support a means for transmitting a WUS that identifies at least a first on-demand SSB of the set of multiple on-demand SSBs, the WUS including an indication of at least the first on-demand SSB that is requested for transmission. The SSB manager 635 is capable of, configured to, or operable to support a means for monitoring for the first on-demand SSB.

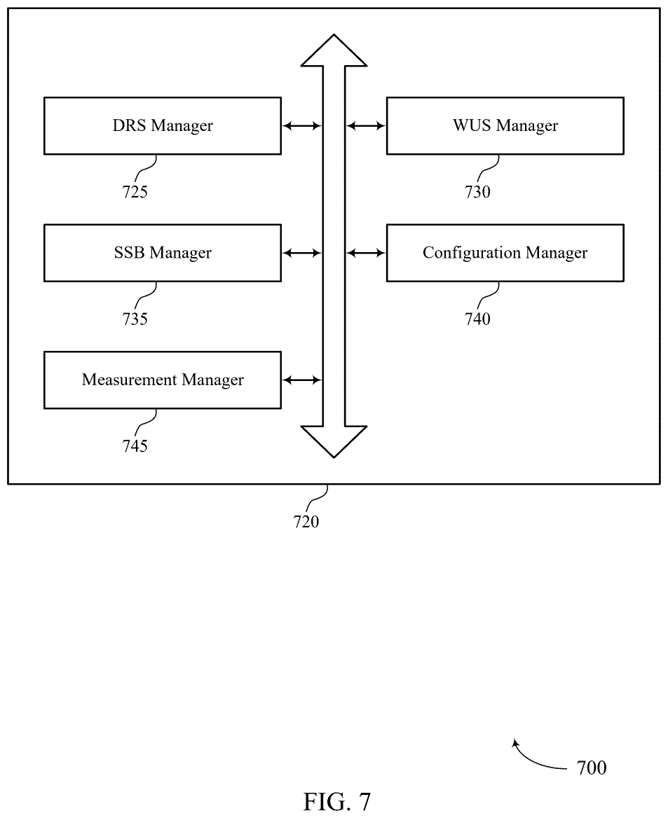

FIG. 7 shows a block diagram 700 of a communications manager 720 that supports techniques for on-demand SSB transmission in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for on-demand SSB transmission as described herein. For example, the communications manager 720 may include a DRS manager 725, a WUS manager 730, an SSB manager 735, a configuration manager 740, a measurement manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The DRS manager 725 is capable of, configured to, or operable to support a means for receiving one or more DRSs, each of the one or more DRSs is associated with a different SSB of a set of multiple on-demand SSBs. The WUS manager 730 is capable of, configured to, or operable to support a means for transmitting a WUS that identifies at least a first on-demand SSB of the set of multiple on-demand SSBs, the WUS including an indication of at least the first on-demand SSB that is requested for transmission. The SSB manager 735 is capable of, configured to, or operable to support a means for monitoring for the first on-demand SSB.

In some examples, the WUS manager 730 is capable of, configured to, or operable to support a means for selecting a codepoint or a bitmap that indicates at least the first on-demand SSB from a set of available codepoints or bitmaps that indicate different combinations of the set of multiple on-demand SSBs that are requested for transmission, and where the WUS includes the codepoint or bitmap.

In some examples, the WUS manager 730 is capable of, configured to, or operable to support a means for selecting a preamble for transmission of the WUS from a set of available preambles that indicates at least the first on-demand SSB is requested for transmission.

In some examples, each preamble of the set of available preambles is associated with a different combination of on-demand SSBs of the set of multiple on-demand SSBs that are requested for transmission. In some examples, the configuration manager 740 is capable of, configured to, or operable to support a means for receiving configuration information that indicates a quantity of on-demand SSBs that can be requested by the UE, where the configuration information is received in one or more of RRC configuration signaling, DCI, or a MAC-CE.

In some examples, the measurement manager 745 is capable of, configured to, or operable to support a means for measuring a signal strength of at least two DRSs. In some examples, the measurement manager 745 is capable of, configured to, or operable to support a means for identifying a first discovery signal associated with the first on-demand SSB based on the signal strength of each of the at least two DRSs. In some examples, the first discovery signal is identified based on a RSRP that exceeds a RSRP threshold value.

In some examples, to support transmitting the WUS, the WUS manager 730 is capable of, configured to, or operable to support a means for transmitting the WUS in a first uplink WUS occasion, where the first uplink WUS occasion is associated with a second on-demand SSB that is different than the first on-demand SSB, and where the WUS includes a request for transmission of both the first on-demand SSB and the second on-demand SSB. In some examples, the request for transmission of the first on-demand SSB is indicated by a preamble of the WUS that is associated with the first on-demand SSB, and the request for transmission of the second on-demand SSB is indicated by the first uplink WUS occasion used to transmit the WUS.

In some examples, the WUS manager 730 is capable of, configured to, or operable to support a means for retransmitting the WUS on one or more uplink WUS occasions subsequent to an initial transmission of the WUS. In some examples, the one or more DRSs are transmitted during a predefined time window, and where on-demand SSBs associated with DRSs transmitted outside of a duration of the predefined time window are not requested by the WUS. In some examples, the first on-demand SSB is requested for multiple periods of SSB transmissions.

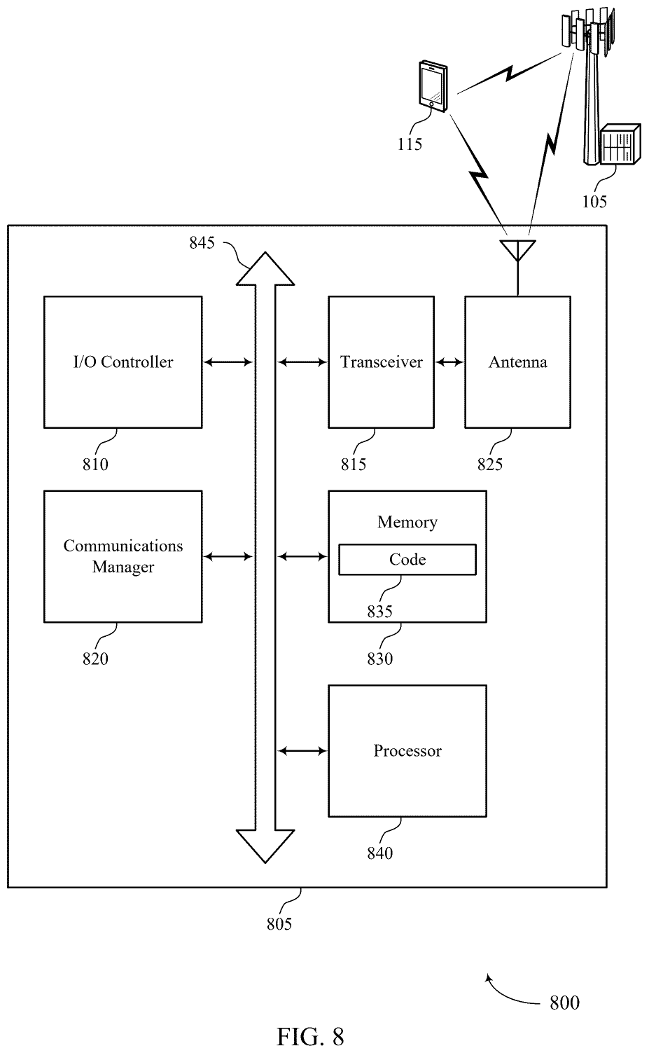

FIG. 8 shows a diagram of a system 800 including a device 805 that supports techniques for on-demand SSB transmission in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for on-demand SSB transmission). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving one or more DRSs, each of the one or more DRSs is associated with a different SSB of a set of multiple on-demand SSBs. The communications manager 820 is capable of, configured to, or operable to support a means for transmitting a WUS that identifies at least a first on-demand SSB of the set of multiple on-demand SSBs, the WUS including an indication of at least the first on-demand SSB that is requested for transmission. The communications manager 820 is capable of, configured to, or operable to support a means for monitoring for the first on-demand SSB.

By including or configuring the communications manager 820 in accordance with examples as described herein, the device 805 may support techniques for WUS transmission that request on-demand SSB transmissions of one or multiple SSBs, which can provide for reduced quantities of WUS transmissions and may enhance network efficiency and reliability, and reduce power consumption.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for on-demand SSB transmission as described herein, or the at least one processor 840 and the at least one memory 830 may be otherwise configured to, individually or collectively, perform or support such operations.

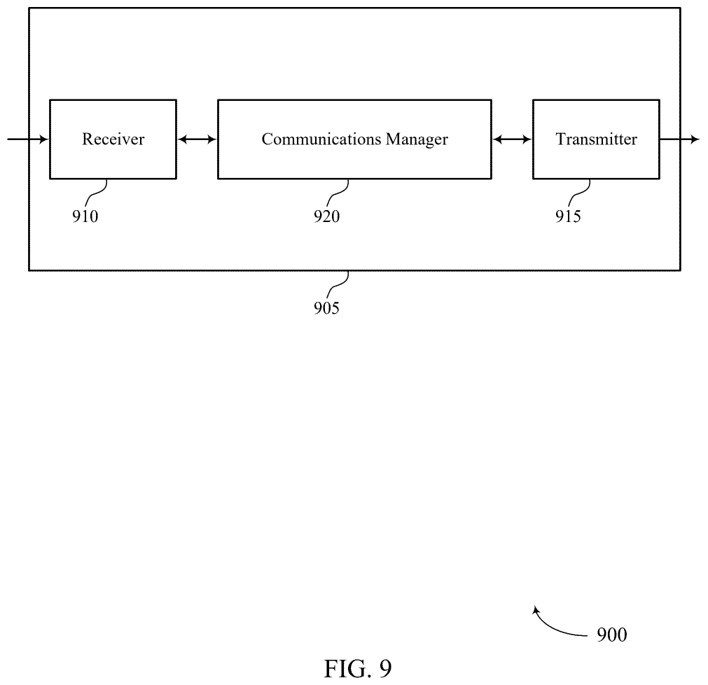

FIG. 9 shows a block diagram 900 of a device 905 that supports techniques for on-demand SSB transmission in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for on-demand SSB transmission as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting a set of multiple DRSs, each of the set of multiple DRSs is associated with a different SSB of a set of multiple on-demand SSBs. The communications manager 920 is capable of, configured to, or operable to support a means for receiving, from a UE, a WUS that identifies at least a first on-demand SSB of the set of multiple on-demand SSBs, the WUS including an indication of at least the first on-demand SSB that is requested for transmission. The communications manager 920 is capable of, configured to, or operable to support a means for transmitting at least the first on-demand SSB based on the WUS.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for WUS transmission that request on-demand SSB transmissions of one or multiple SSBs, which can provide for reduced quantities of WUS transmissions and may enhance network efficiency and reliability, and reduce power consumption.

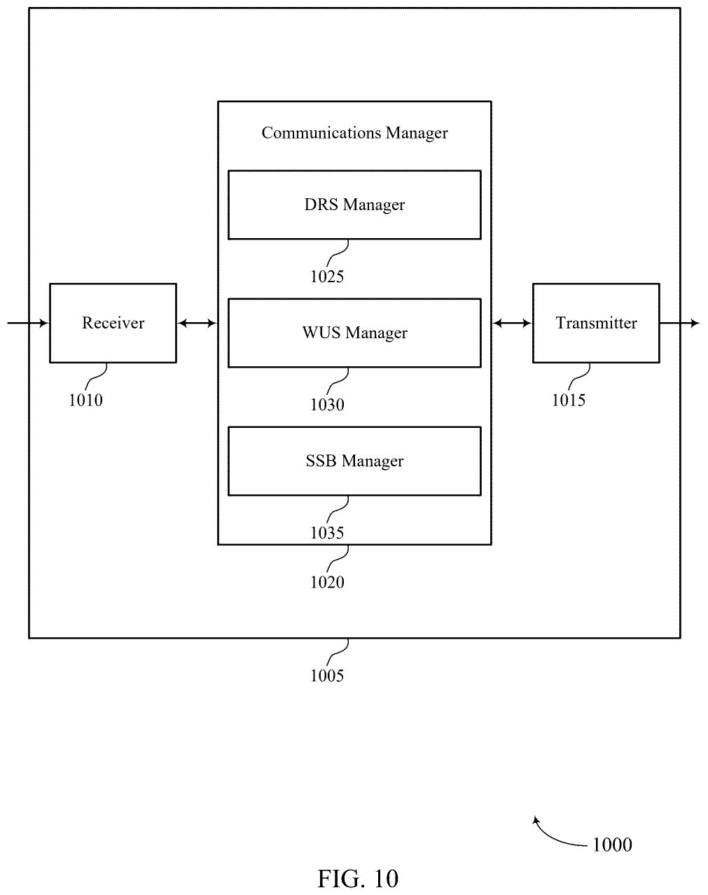

FIG. 10 shows a block diagram 1000 of a device 1005 that supports techniques for on-demand SSB transmission in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for on-demand SSB transmission as described herein. For example, the communications manager 1020 may include a DRS manager 1025, a WUS manager 1030, an SSB manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The DRS manager 1025 is capable of, configured to, or operable to support a means for transmitting a set of multiple DRSs, each of the set of multiple DRSs is associated with a different SSB of a set of multiple on-demand SSBs. The WUS manager 1030 is capable of, configured to, or operable to support a means for receiving, from a UE, a WUS that identifies at least a first on-demand SSB of the set of multiple on-demand SSBs, the WUS including an indication of at least the first on-demand SSB that is requested for transmission. The SSB manager 1035 is capable of, configured to, or operable to support a means for transmitting at least the first on-demand SSB based on the WUS.

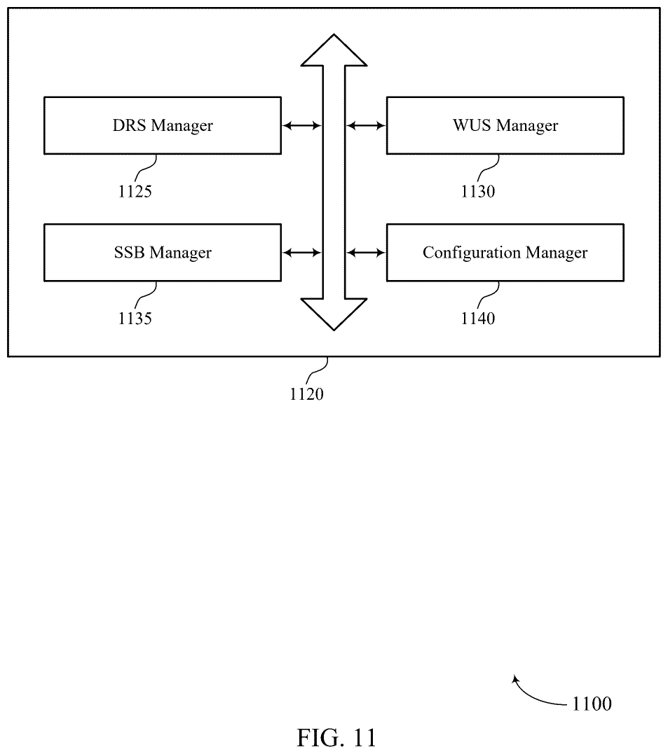

FIG. 11 shows a block diagram 1100 of a communications manager 1120 that supports techniques for on-demand SSB transmission in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for on-demand SSB transmission as described herein. For example, the communications manager 1120 may include a DRS manager 1125, a WUS manager 1130, an SSB manager 1135, a configuration manager 1140, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The DRS manager 1125 is capable of, configured to, or operable to support a means for transmitting a set of multiple DRSs, each of the set of multiple DRSs is associated with a different SSB of a set of multiple on-demand SSBs. The WUS manager 1130 is capable of, configured to, or operable to support a means for receiving, from a UE, a WUS that identifies at least a first on-demand SSB of the set of multiple on-demand SSBs, the WUS including an indication of at least the first on-demand SSB that is requested for transmission. The SSB manager 1135 is capable of, configured to, or operable to support a means for transmitting at least the first on-demand SSB based on the WUS.

In some examples, the WUS manager 1130 is capable of, configured to, or operable to support a means for decoding a codepoint or a bitmap from the WUS that indicates at least the first on-demand SSB, where the codepoint or bitmap is from a set of available codepoints or bitmaps that indicate different combinations of the set of multiple on-demand SSBs that are requested for transmission.

In some examples, the WUS manager 1130 is capable of, configured to, or operable to support a means for identifying the first on-demand SSB is requested based on a preamble of the WUS. In some examples, each preamble of a set of available preambles is associated with a different combination of on-demand SSBs of the set of multiple on-demand SSBs that are requested for transmission.

In some examples, the configuration manager 1140 is capable of, configured to, or operable to support a means for transmitting configuration information to the UE that indicates a quantity of on-demand SSBs that can be requested by the UE, where the configuration information is transmitted in one or more of RRC configuration signaling, DCI, or a MAC-CE. In some examples, the configuration manager 1140 is capable of, configured to, or operable to support a means for transmitting configuration information to the UE that configures the UE to select a first DRS associated with the first on-demand SSB based on a signal strength of two or more measured DRSs. In some examples, the configuration information includes a RSRP threshold value for selecting one or more DRSs.

In some examples, to support receiving the WUS, the WUS manager 1130 is capable of, configured to, or operable to support a means for receiving the WUS in a first uplink WUS occasion, where the first uplink WUS occasion is associated with a second on-demand SSB that is different than the first on-demand SSB, and where the WUS includes a request for transmission of both the first on-demand SSB and the second on-demand SSB. In some examples, the request for transmission of the first on-demand SSB is indicated by a preamble of the WUS that is associated with the first on-demand SSB, and the request for transmission of the second on-demand SSB is indicated by the first uplink WUS occasion used to transmit the WUS.

In some examples, the WUS manager 1130 is capable of, configured to, or operable to support a means for receiving one or more instances of the WUS on at least one uplink WUS occasion of a set of uplink WUS occasions. In some examples, the set of multiple DRSs are transmitted during a predefined time window, and where on-demand SSBs associated with DRSs transmitted outside of a duration of the predefined time window are not requested by the WUS. In some examples, the first on-demand SSB is requested for multiple periods of SSB transmissions.

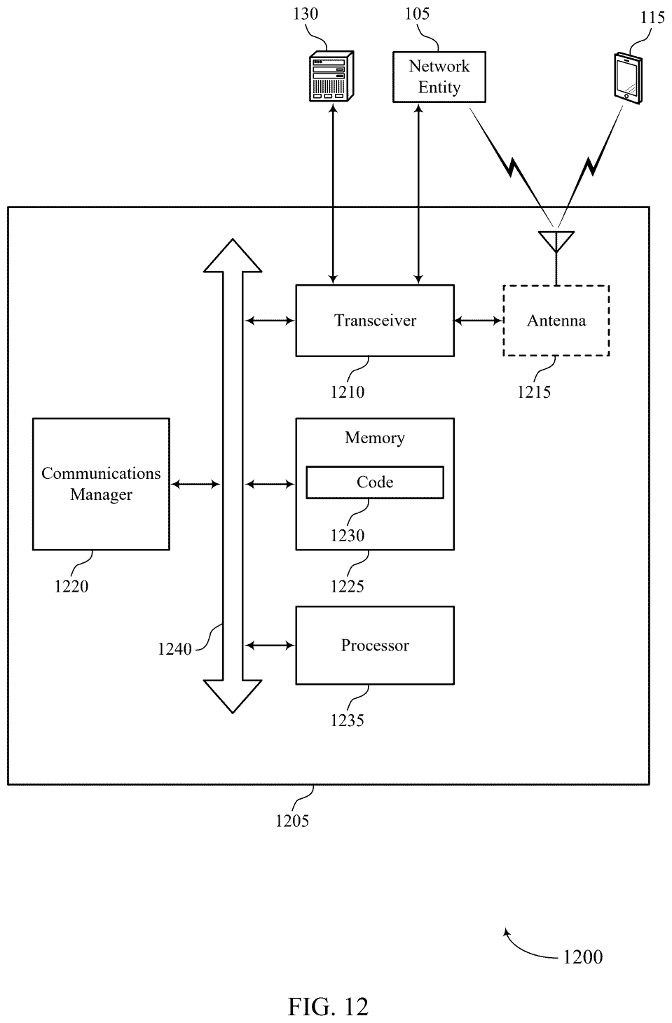

FIG. 12 shows a diagram of a system 1200 including a device 1205 that supports techniques for on-demand SSB transmission in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for on-demand SSB transmission). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting a set of multiple DRSs, each of the set of multiple DRSs is associated with a different SSB of a set of multiple on-demand SSBs. The communications manager 1220 is capable of, configured to, or operable to support a means for receiving, from a UE, a WUS that identifies at least a first on-demand SSB of the set of multiple on-demand SSBs, the WUS including an indication of at least the first on-demand SSB that is requested for transmission. The communications manager 1220 is capable of, configured to, or operable to support a means for transmitting at least the first on-demand SSB based on the WUS.

By including or configuring the communications manager 1220 in accordance with examples as described herein, the device 1205 may support techniques for WUS transmission that request on-demand SSB transmissions of one or multiple SSBs, which can provide for reduced quantities of WUS transmissions and may enhance network efficiency and reliability, and reduce power consumption.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for on-demand SSB transmission as described herein, or the at least one processor 1235 and the at least one memory 1225 may be otherwise configured to, individually or collectively, perform or support such operations.

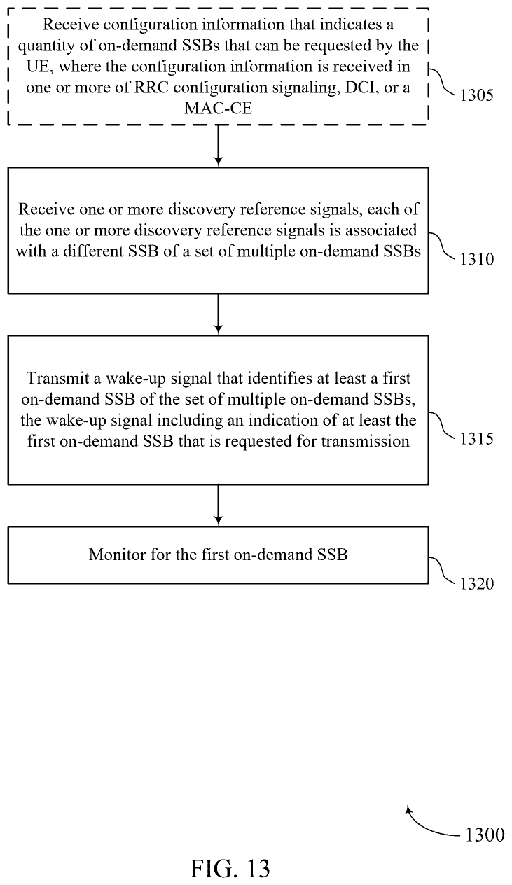

FIG. 13 shows a flowchart illustrating a method 1300 that supports techniques for on-demand SSB transmission in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

Optionally, at 1305, the method may include receiving configuration information that indicates a quantity of on-demand SSBs that can be requested by the UE, where the configuration information is received in one or more of RRC configuration signaling. DCI, or a MAC-CE. The operations of block 1305 may be performed in accordance with examples as disclosed herein. In some examples, aspects of the operations of 1305 may be performed by a configuration manager 740 as described with reference to FIG. 7.

At 1310, the method may include receiving one or more DRSs, each of the one or more DRSs is associated with a different SSB of a set of multiple on-demand SSBs. The operations of block 1310 may be performed in accordance with examples as disclosed herein. In some examples, aspects of the operations of 1310 may be performed by a DRS manager 725 as described with reference to FIG. 7.

At 1315, the method may include transmitting a WUS that identifies at least a first on-demand SSB of the set of multiple on-demand SSBs, the WUS including an indication of at least the first on-demand SSB that is requested for transmission. The operations of block 1315 may be performed in accordance with examples as disclosed herein. In some examples, aspects of the operations of 1315 may be performed by a WUS manager 730 as described with reference to FIG. 7.

At 1320, the method may include monitoring for the first on-demand SSB. The operations of block 1320 may be performed in accordance with examples as disclosed herein. In some examples, aspects of the operations of 1320 may be performed by an SSB manager 735 as described with reference to FIG. 7.

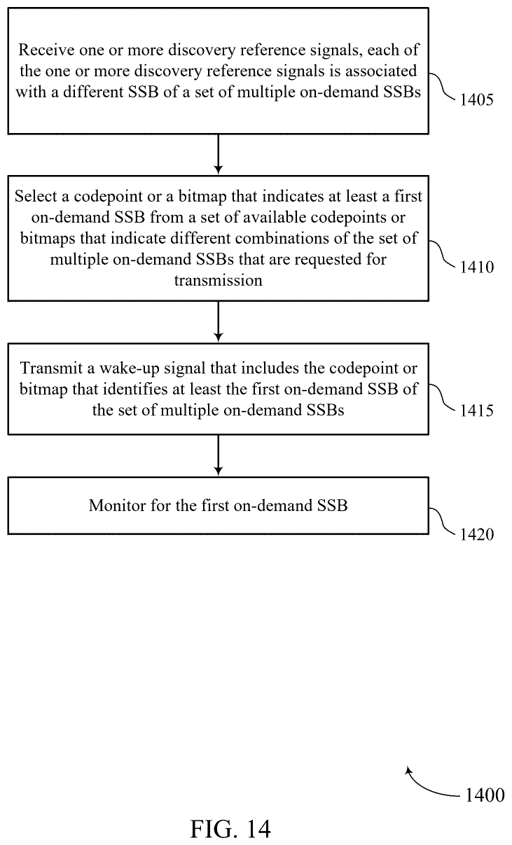

FIG. 14 shows a flowchart illustrating a method 1400 that supports techniques for on-demand SSB transmission in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving one or more DRSs, each of the one or more DRSs is associated with a different SSB of a set of multiple on-demand SSBs. The operations of block 1405 may be performed in accordance with examples as disclosed herein. In some examples, aspects of the operations of 1405 may be performed by a DRS manager 725 as described with reference to FIG. 7.

At 1410, the method may include selecting a codepoint or a bitmap that indicates at least a first on-demand SSB from a set of available codepoints or bitmaps that indicate different combinations of the set of multiple on-demand SSBs that are requested for transmission. The operations of block 1410 may be performed in accordance with examples as disclosed herein. In some examples, aspects of the operations of 1410 may be performed by a WUS manager 730 as described with reference to FIG. 7.

At 1415, the method may include transmitting a WUS that includes the codepoint or bitmap that identifies at least the first on-demand SSB of the set of multiple on-demand SSBs. The operations of block 1415 may be performed in accordance with examples as disclosed herein. In some examples, aspects of the operations of 1415 may be performed by a WUS manager 730 as described with reference to FIG. 7.

At 1420, the method may include monitoring for the first on-demand SSB. The operations of block 1420 may be performed in accordance with examples as disclosed herein. In some examples, aspects of the operations of 1420 may be performed by an SSB manager 735 as described with reference to FIG. 7.

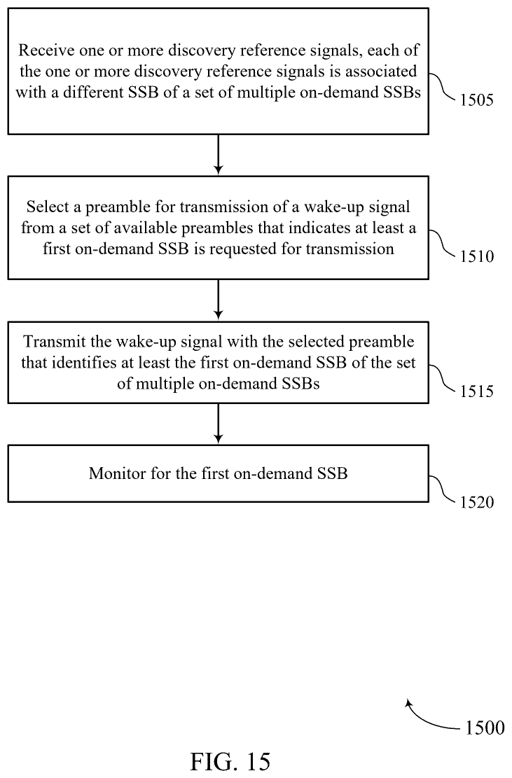

FIG. 15 shows a flowchart illustrating a method 1500 that supports techniques for on-demand SSB transmission in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving one or more DRSs, each of the one or more DRSs is associated with a different SSB of a set of multiple on-demand SSBs. The operations of block 1505 may be performed in accordance with examples as disclosed herein. In some examples, aspects of the operations of 1505 may be performed by a DRS manager 725 as described with reference to FIG. 7.

At 1510, the method may include selecting a preamble for transmission of a WUS from a set of available preambles that indicates at least the first on-demand SSB is requested for transmission. The operations of block 1510 may be performed in accordance with examples as disclosed herein. In some examples, aspects of the operations of 1510 may be performed by a WUS manager 730 as described with reference to FIG. 7.

At 1515, the method may include transmitting the WUS with the selected preamble that identifies at least the first on-demand SSB of the set of multiple on-demand SSBs. The operations of block 1515 may be performed in accordance with examples as disclosed herein. In some examples, aspects of the operations of 1515 may be performed by a WUS manager 730 as described with reference to FIG. 7.

At 1520, the method may include monitoring for the first on-demand SSB. The operations of block 1520 may be performed in accordance with examples as disclosed herein. In some examples, aspects of the operations of 1520 may be performed by an SSB manager 735 as described with reference to FIG. 7.

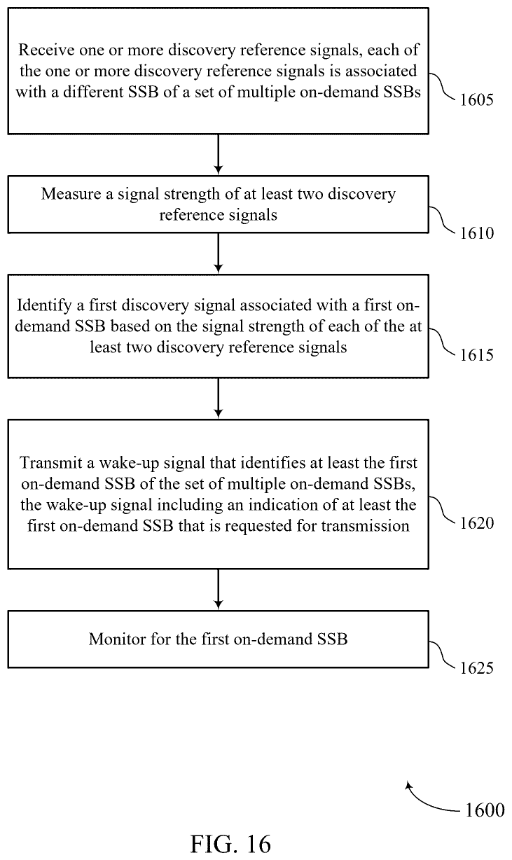

FIG. 16 shows a flowchart illustrating a method 1600 that supports techniques for on-demand SSB transmission in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1605, the method may include receiving one or more DRSs, each of the one or more DRSs is associated with a different SSB of a set of multiple on-demand SSBs. The operations of block 1605 may be performed in accordance with examples as disclosed herein. In some examples, aspects of the operations of 1605 may be performed by a DRS manager 725 as described with reference to FIG. 7.

At 1610, the method may include measuring a signal strength of at least two DRSs. The operations of block 1610 may be performed in accordance with examples as disclosed herein. In some examples, aspects of the operations of 1610 may be performed by a measurement manager 745 as described with reference to FIG. 7.

At 1615, the method may include identifying a first discovery signal associated with a first on-demand SSB based on the signal strength of each of the at least two DRSs. The operations of block 1615 may be performed in accordance with examples as disclosed herein. In some examples, aspects of the operations of 1615 may be performed by a measurement manager 745 as described with reference to FIG. 7.

At 1620, the method may include transmitting a WUS that identifies at least the first on-demand SSB of the set of multiple on-demand SSBs, the WUS including an indication of at least the first on-demand SSB that is requested for transmission. The operations of block 1620 may be performed in accordance with examples as disclosed herein. In some examples, aspects of the operations of 1620 may be performed by a WUS manager 730 as described with reference to FIG. 7.

At 1625, the method may include monitoring for the first on-demand SSB. The operations of block 1625 may be performed in accordance with examples as disclosed herein. In some examples, aspects of the operations of 1625 may be performed by an SSB manager 735 as described with reference to FIG. 7.

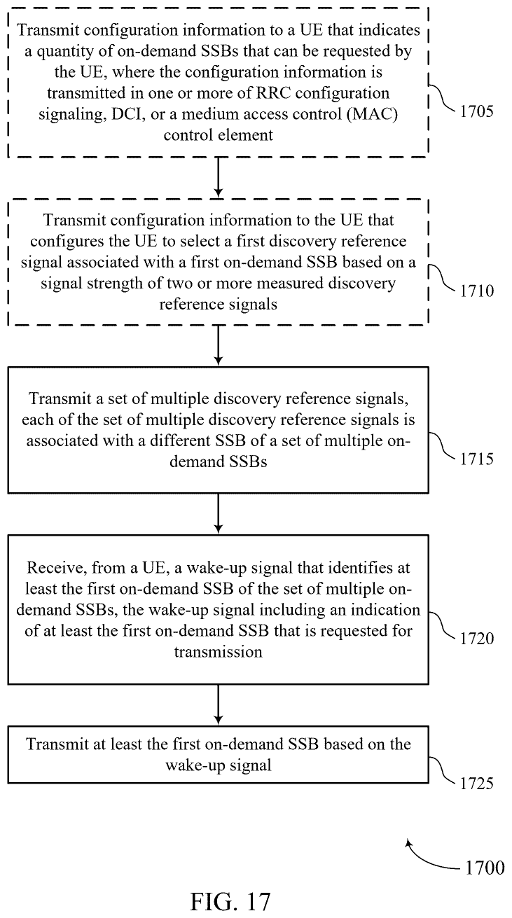

FIG. 17 shows a flowchart illustrating a method 1700 that supports techniques for on-demand SSB transmission in accordance with aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

Optionally, at 1705, the method may include transmitting configuration information to a UE that indicates a quantity of on-demand SSBs that can be requested by the UE, where the configuration information is transmitted in one or more of RRC configuration signaling, DCI, or a MAC-CE. The operations of block 1705 may be performed in accordance with examples as disclosed herein. In some examples, aspects of the operations of 1705 may be performed by a configuration manager 1140 as described with reference to FIG. 11.

Optionally, at 1710, the method may include transmitting configuration information to the UE that configures the UE to select a first DRS associated with a first on-demand SSB based on a signal strength of two or more measured DRSs. The operations of block 1710 may be performed in accordance with examples as disclosed herein. In some examples, aspects of the operations of 1710 may be performed by a configuration manager 1140 as described with reference to FIG. 11.

At 1715, the method may include transmitting a set of multiple DRSs, each of the set of multiple DRSs is associated with a different SSB of a set of multiple on-demand SSBs. The operations of block 1715 may be performed in accordance with examples as disclosed herein. In some examples, aspects of the operations of 1715 may be performed by a DRS manager 1125 as described with reference to FIG. 11.

At 1720, the method may include receiving, from the UE, a WUS that identifies at least a first on-demand SSB of the set of multiple on-demand SSBs, the WUS including an indication of at least the first on-demand SSB that is requested for transmission. The operations of block 1720 may be performed in accordance with examples as disclosed herein. In some examples, aspects of the operations of 1720 may be performed by a WUS manager 1130 as described with reference to FIG. 11.

At 1725, the method may include transmitting at least the first on-demand SSB based on the WUS. The operations of block 1725 may be performed in accordance with examples as disclosed herein. In some examples, aspects of the operations of 1725 may be performed by an SSB manager 1135 as described with reference to FIG. 11.

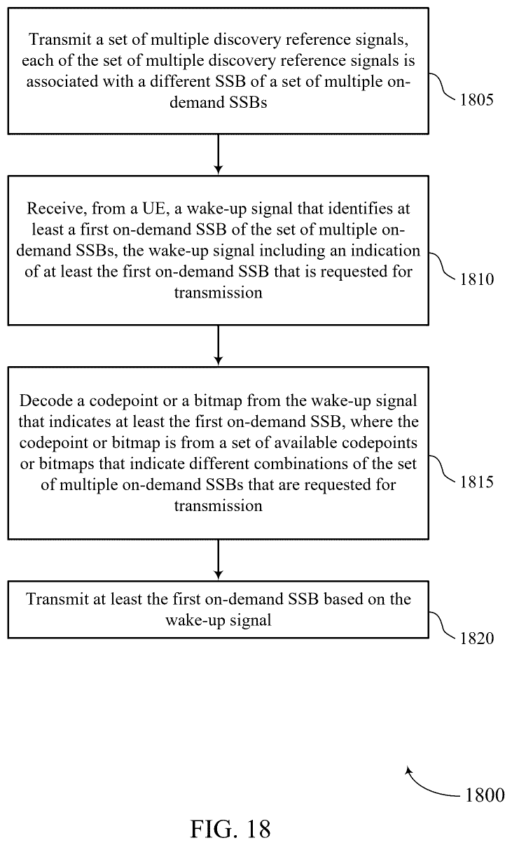

FIG. 18 shows a flowchart illustrating a method 1800 that supports techniques for on-demand SSB transmission in accordance with aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include transmitting a set of multiple DRSs, each of the set of multiple DRSs is associated with a different SSB of a set of multiple on-demand SSBs. The operations of block 1805 may be performed in accordance with examples as disclosed herein. In some examples, aspects of the operations of 1805 may be performed by a DRS manager 1125 as described with reference to FIG. 11.

At 1810, the method may include receiving, from a UE, a WUS that identifies at least a first on-demand SSB of the set of multiple on-demand SSBs, the WUS including an indication of at least the first on-demand SSB that is requested for transmission. The operations of block 1810 may be performed in accordance with examples as disclosed herein. In some examples, aspects of the operations of 1810 may be performed by a WUS manager 1130 as described with reference to FIG. 11.

At 1815, the method may include decoding a codepoint or a bitmap from the WUS that indicates at least the first on-demand SSB, where the codepoint or bitmap is from a set of available codepoints or bitmaps that indicate different combinations of the set of multiple on-demand SSBs that are requested for transmission. The operations of block 1815 may be performed in accordance with examples as disclosed herein. In some examples, aspects of the operations of 1815 may be performed by a WUS manager 1130 as described with reference to FIG. 11.

At 1820, the method may include transmitting at least the first on-demand SSB based on the WUS. The operations of block 1820 may be performed in accordance with examples as disclosed herein. In some examples, aspects of the operations of 1820 may be performed by an SSB manager 1135 as described with reference to FIG. 11.

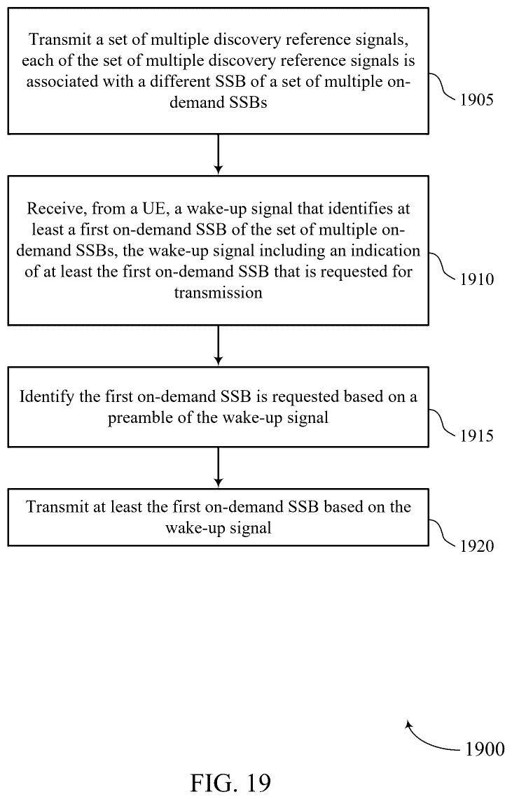

FIG. 19 shows a flowchart illustrating a method 1900 that supports techniques for on-demand SSB transmission in accordance with aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a set of multiple DRSs, each of the set of multiple DRSs is associated with a different SSB of a set of multiple on-demand SSBs. The operations of block 1905 may be performed in accordance with examples as disclosed herein. In some examples, aspects of the operations of 1905 may be performed by a DRS manager 1125 as described with reference to FIG. 11.

At 1910, the method may include receiving, from a UE, a WUS that identifies at least a first on-demand SSB of the set of multiple on-demand SSBs, the WUS including an indication of at least the first on-demand SSB that is requested for transmission. The operations of block 1910 may be performed in accordance with examples as disclosed herein. In some examples, aspects of the operations of 1910 may be performed by a WUS manager 1130 as described with reference to FIG. 11.

At 1915, the method may include identifying the first on-demand SSB is requested based on a preamble of the WUS. The operations of block 1915 may be performed in accordance with examples as disclosed herein. In some examples, aspects of the operations of 1915 may be performed by a WUS manager 1130 as described with reference to FIG. 11.

At 1920, the method may include transmitting at least the first on-demand SSB based on the WUS. The operations of block 1920 may be performed in accordance with examples as disclosed herein. In some examples, aspects of the operations of 1920 may be performed by an SSB manager 1135 as described with reference to FIG. 11.

The following provides an overview of aspects of the present disclosure:

Aspect 1: A method for wireless communications at a UE, comprising: receiving one or more discovery reference signals, each of the one or more discovery reference signals is associated with a different SSB of a plurality of on-demand SSBs; transmitting a wake-up signal that identifies at least a first on-demand SSB of the plurality of on-demand SSBs, the wake-up signal including an indication of at least the first on-demand SSB that is requested for transmission; and monitoring for the first on-demand SSB.

Aspect 2: The method of aspect 1, further comprising: selecting a codepoint or a bitmap that indicates at least the first on-demand SSB from a set of available codepoints or bitmaps that indicate different combinations of the plurality of on-demand SSBs that are requested for transmission, and wherein the wake-up signal includes the codepoint or bitmap.

Aspect 3: The method of any of aspects 1 through 2, further comprising: selecting a preamble for transmission of the wake-up signal from a set of available preambles that indicates at least the first on-demand SSB is requested for transmission.

Aspect 4: The method of aspect 3, wherein each preamble of the set of available preambles is associated with a different combination of on-demand SSBs of the plurality of on-demand SSBs that are requested for transmission.

Aspect 5: The method of any of aspects 1 through 4, further comprising: receiving configuration information that indicates a quantity of on-demand SSBs that can be requested by the UE, wherein the configuration information is received in one or more of RRC configuration signaling, DCI, or a medium access control (MAC) control element.

Aspect 6: The method of any of aspects 1 through 5, further comprising: measuring a signal strength of at least two discovery reference signals; and identifying a first discovery signal associated with the first on-demand SSB based at least in part on the signal strength of each of the at least two discovery reference signals.

Aspect 7: The method of aspect 6, wherein the first discovery signal is identified based at least in part on a reference signal received power (RSRP) that exceeds a RSRP threshold value.

Aspect 8: The method of any of aspects 1 through 7, wherein the transmitting the wake-up signal comprises: transmitting the wake-up signal in a first uplink wake-up signal occasion, wherein the first uplink wake-up signal occasion is associated with a second on-demand SSB that is different than the first on-demand SSB, and wherein the wake-up signal includes a request for transmission of both the first on-demand SSB and the second on-demand SSB.

Aspect 9: The method of aspect 8, wherein the request for transmission of the first on-demand SSB is indicated by a preamble of the wake-up signal that is associated with the first on-demand SSB, and the request for transmission of the second on-demand SSB is indicated by the first uplink wake-up signal occasion used to transmit the wake-up signal.

Aspect 10: The method of any of aspects 1 through 9, further comprising: retransmitting the wake-up signal on one or more uplink wake-up signal occasions subsequent to an initial transmission of the wake-up signal.

Aspect 11: The method of any of aspects 1 through 10, wherein the one or more discovery reference signals are transmitted during a predefined time window, and wherein on-demand SSBs associated with discovery reference signals transmitted outside of a duration of the predefined time window are not requested by the wake-up signal.

Aspect 12: The method of any of aspects 1 through 11, wherein the first on-demand SSB is requested for multiple periods of SSB transmissions.

Aspect 13: A method for wireless communications at a network entity, comprising: transmitting a plurality of discovery reference signals, each of the plurality of discovery reference signals is associated with a different SSB of a plurality of on-demand SSBs; receiving, from a UE, a wake-up signal that identifies at least a first on-demand SSB of the plurality of on-demand SSBs, the wake-up signal including an indication of at least the first on-demand SSB that is requested for transmission; and transmitting at least the first on-demand SSB based at least in part on the wake-up signal.

Aspect 14: The method of aspect 13, further comprising: decoding a codepoint or a bitmap from the wake-up signal that indicates at least the first on-demand SSB, wherein the codepoint or bitmap is from a set of available codepoints or bitmaps that indicate different combinations of the plurality of on-demand SSBs that are requested for transmission.

Aspect 15: The method of any of aspects 13 through 14, further comprising: identifying the first on-demand SSB is requested based at least in part on a preamble of the wake-up signal.

Aspect 16: The method of aspect 15, wherein each preamble of a set of available preambles is associated with a different combination of on-demand SSBs of the plurality of on-demand SSBs that are requested for transmission.

Aspect 17: The method of any of aspects 13 through 16, further comprising: transmitting configuration information to the UE that indicates a quantity of on-demand SSBs that can be requested by the UE, wherein the configuration information is transmitted in one or more of RRC configuration signaling, DCI, or a medium access control (MAC) control element.

Aspect 18: The method of any of aspects 13 through 17, further comprising: transmitting configuration information to the UE that configures the UE to select a first discovery reference signal associated with the first on-demand SSB based at least in part on a signal strength of two or more measured discovery reference signals.

Aspect 19: The method of aspect 18, wherein the configuration information includes a reference signal received power (RSRP) threshold value for selecting one or more discovery reference signals.

Aspect 20: The method of any of aspects 13 through 19, wherein the receiving the wake-up signal comprises: receiving the wake-up signal in a first uplink wake-up signal occasion, wherein the first uplink wake-up signal occasion is associated with a second on-demand SSB that is different than the first on-demand SSB, and wherein the wake-up signal includes a request for transmission of both the first on-demand SSB and the second on-demand SSB.

Aspect 21: The method of aspect 20, wherein the request for transmission of the first on-demand SSB is indicated by a preamble of the wake-up signal that is associated with the first on-demand SSB, and the request for transmission of the second on-demand SSB is indicated by the first uplink wake-up signal occasion used to transmit the wake-up signal.

Aspect 22: The method of any of aspects 13 through 21, further comprising: receiving one or more instances of the wake-up signal on at least one uplink wake-up signal occasion of a set of uplink wake-up signal occasions.

Aspect 23: The method of any of aspects 13 through 22, wherein the plurality of discovery reference signals are transmitted during a predefined time window, and wherein on-demand SSBs associated with discovery reference signals transmitted outside of a duration of the predefined time window are not requested by the wake-up signal.

Aspect 24: The method of any of aspects 13 through 23, wherein the first on-demand SSB is requested for multiple periods of SSB transmissions.

Aspect 25: A UE for wireless communications, comprising one or more memories storing processor-executable code, and one or more processors coupled with the one or more memories and individually or collectively operable to execute the code to cause the UE to perform a method of any of aspects 1 through 12.

Aspect 26: A UE for wireless communications, comprising at least one means for performing a method of any of aspects 1 through 12.

Aspect 27: A non-transitory computer-readable medium storing code for wireless communications, the code comprising instructions executable by a processor to perform a method of any of aspects 1 through 12.

Aspect 28: A network entity for wireless communications, comprising one or more memories storing processor-executable code, and one or more processors coupled with the one or more memories and individually or collectively operable to execute the code to cause the network entity to perform a method of any of aspects 13 through 24.

Aspect 29: A network entity for wireless communications, comprising at least one means for performing a method of any of aspects 13 through 24.

Aspect 30: A non-transitory computer-readable medium storing code for wireless communications, the code comprising instructions executable by a processor to perform a method of any of aspects 13 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more discovery reference signals, each of the one or more discovery reference signals is associated with a different synchronization signal block of a plurality of on-demand synchronization signal blocks;
transmit a wake-up signal that identifies at least a first on-demand synchronization signal block of the plurality of on-demand synchronization signal blocks, the wake-up signal including an indication of at least the first on-demand synchronization signal block that is requested for transmission; and
monitor for the first on-demand synchronization signal block.

2. The UE of claim 1, wherein the one or more processors are individually or collectively further operable to execute the code to cause the UE to:
select a codepoint or a bitmap that indicates at least the first on-demand synchronization signal block from a set of available codepoints or bitmaps that indicate different combinations of the plurality of on-demand synchronization signal blocks that are requested for transmission, and wherein the wake-up signal includes the codepoint or bitmap.

3. The UE of claim 1, wherein the one or more processors are individually or collectively further operable to execute the code to cause the UE to:
select a preamble for transmission of the wake-up signal from a set of available preambles that indicates at least the first on-demand synchronization signal block is requested for transmission.

4. The UE of claim 3, wherein each preamble of the set of available preambles is associated with a different combination of on-demand synchronization signal blocks of the plurality of on-demand synchronization signal blocks that are requested for transmission.

5. The UE of claim 1, wherein the one or more processors are individually or collectively further operable to execute the code to cause the UE to:
receive configuration information that indicates a quantity of on-demand synchronization signal blocks that can be requested by the UE, wherein the configuration information is received in one or more of radio resource control (RRC) configuration signaling, downlink control information (DCI), or a medium access control (MAC) control element.

6. The UE of claim 1, wherein the one or more processors are individually or collectively further operable to execute the code to cause the UE to:
measure a signal strength of at least two discovery reference signals; and
identify a first discovery signal associated with the first on-demand synchronization signal block based at least in part on the signal strength of each of the at least two discovery reference signals.

7. The UE of claim 6, wherein the first discovery signal is identified based at least in part on a reference signal received power (RSRP) that exceeds a RSRP threshold value.

8. The UE of claim 1, wherein, to transmit the wake-up signal, the one or more processors are individually or collectively operable to execute the code to cause the UE to:
transmit the wake-up signal in a first uplink wake-up signal occasion, wherein the first uplink wake-up signal occasion is associated with a second on-demand synchronization signal block that is different than the first on-demand synchronization signal block, and wherein the wake-up signal includes a request for transmission of both the first on-demand synchronization signal block and the second on-demand synchronization signal block.

9. The UE of claim 8, wherein the request for transmission of the first on-demand synchronization signal block is indicated by a preamble of the wake-up signal that is associated with the first on-demand synchronization signal block, and the request for transmission of the second on-demand synchronization signal block is indicated by the first uplink wake-up signal occasion used to transmit the wake-up signal.

10. The UE of claim 1, wherein the one or more processors are individually or collectively further operable to execute the code to cause the UE to:
retransmit the wake-up signal on one or more uplink wake-up signal occasions subsequent to an initial transmission of the wake-up signal.

11. The UE of claim 1, wherein the one or more discovery reference signals are transmitted during a predefined time window, and wherein on-demand synchronization signal blocks associated with discovery reference signals transmitted outside of a duration of the predefined time window are not requested by the wake-up signal.

12. The UE of claim 1, wherein:
the first on-demand synchronization signal block is requested for multiple periods of synchronization signal block transmissions.

13. A network entity, comprising:
one or more memories storing processor-executable code; and
one or more processors coupled with the one or more memories and individually or collectively operable to execute the code to cause the network entity to:
transmit a plurality of discovery reference signals, each of the plurality of discovery reference signals is associated with a different synchronization signal block of a plurality of on-demand synchronization signal blocks;
receive, from a user equipment (UE), a wake-up signal that identifies at least a first on-demand synchronization signal block of the plurality of on-demand synchronization signal blocks, the wake-up signal including an indication of at least the first on-demand synchronization signal block that is requested for transmission; and
transmit at least the first on-demand synchronization signal block based at least in part on the wake-up signal.

14. The network entity of claim 13, wherein the one or more processors are individually or collectively further operable to execute the code to cause the network entity to:
decode a codepoint or a bitmap from the wake-up signal that indicates at least the first on-demand synchronization signal block, wherein the codepoint or bitmap is from a set of available codepoints or bitmaps that indicate different combinations of the plurality of on-demand synchronization signal blocks that are requested for transmission.

15. The network entity of claim 13, wherein the one or more processors are individually or collectively further operable to execute the code to cause the network entity to:
identify the first on-demand synchronization signal block is requested based at least in part on a preamble of the wake-up signal.

16. The network entity of claim 15, wherein each preamble of a set of available preambles is associated with a different combination of on-demand synchronization signal blocks of the plurality of on-demand synchronization signal blocks that are requested for transmission.

17. The network entity of claim 13, wherein the one or more processors are individually or collectively further operable to execute the code to cause the network entity to:
transmit configuration information to the UE that indicates a quantity of on-demand synchronization signal blocks that can be requested by the UE, wherein the configuration information is transmitted in one or more of radio resource control (RRC) configuration signaling, downlink control information (DCI), or a medium access control (MAC) control element.

18. The network entity of claim 13, wherein the one or more processors are individually or collectively further operable to execute the code to cause the network entity to:
transmit configuration information to the UE that configures the UE to select a first discovery reference signal associated with the first on-demand synchronization signal block based at least in part on a signal strength of two or more measured discovery reference signals.

19. The network entity of claim 18, wherein the configuration information includes a reference signal received power (RSRP) threshold value for selecting one or more discovery reference signals.

20. The network entity of claim 13, wherein, to receive the wake-up signal, the one or more processors are individually or collectively operable to execute the code to cause the network entity to:
receive the wake-up signal in a first uplink wake-up signal occasion, wherein the first uplink wake-up signal occasion is associated with a second on-demand synchronization signal block that is different than the first on-demand synchronization signal block, and wherein the wake-up signal includes a request for transmission of both the first on-demand synchronization signal block and the second on-demand synchronization signal block.

21. The network entity of claim 20, wherein the request for transmission of the first on-demand synchronization signal block is indicated by a preamble of the wake-up signal that is associated with the first on-demand synchronization signal block, and the request for transmission of the second on-demand synchronization signal block is indicated by the first uplink wake-up signal occasion used to transmit the wake-up signal.

22. The network entity of claim 13, wherein the one or more processors are individually or collectively further operable to execute the code to cause the network entity to:
receive one or more instances of the wake-up signal on at least one uplink wake-up signal occasion of a set of uplink wake-up signal occasions.

23. A method for wireless communications at a user equipment (UE), comprising:
receiving one or more discovery reference signals, each of the one or more discovery reference signals is associated with a different synchronization signal block of a plurality of on-demand synchronization signal blocks;
transmitting a wake-up signal that identifies at least a first on-demand synchronization signal block of the plurality of on-demand synchronization signal blocks, the wake-up signal including an indication of at least the first on-demand synchronization signal block that is requested for transmission; and
monitoring for the first on-demand synchronization signal block.

24. The method of claim 23, further comprising:
selecting a codepoint or a bitmap that indicates at least the first on-demand synchronization signal block from a set of available codepoints or bitmaps that indicate different combinations of the plurality of on-demand synchronization signal blocks that are requested for transmission, and wherein the wake-up signal includes the codepoint or bitmap.

25. The method of claim 23, further comprising:
selecting a preamble for transmission of the wake-up signal from a set of available preambles that indicates at least the first on-demand synchronization signal block is requested for transmission.

26. The method of claim 23, further comprising:
measuring a signal strength of at least two discovery reference signals; and
identifying a first discovery signal associated with the first on-demand synchronization signal block based at least in part on the signal strength of each of the at least two discovery reference signals.

27. A method for wireless communications at a network entity, comprising:
transmitting a plurality of discovery reference signals, each of the plurality of discovery reference signals is associated with a different synchronization signal block of a plurality of on-demand synchronization signal blocks;
receiving, from a user equipment (UE), a wake-up signal that identifies at least a first on-demand synchronization signal block of the plurality of on-demand synchronization signal blocks, the wake-up signal including an indication of at least the first on-demand synchronization signal block that is requested for transmission; and
transmitting at least the first on-demand synchronization signal block based at least in part on the wake-up signal.

28. The method of claim 27, further comprising:
decoding a codepoint or a bitmap from the wake-up signal that indicates at least the first on-demand synchronization signal block, wherein the codepoint or bitmap is from a set of available codepoints or bitmaps that indicate different combinations of the plurality of on-demand synchronization signal blocks that are requested for transmission.

29. The method of claim 27, further comprising:
identifying the first on-demand synchronization signal block is requested based at least in part on a preamble of the wake-up signal.

30. The method of claim 27, further comprising:
transmitting configuration information to the UE that configures the UE to select a first discovery reference signal associated with the first on-demand synchronization signal block based at least in part on a signal strength of two or more measured discovery reference signals.
